(19) United States
(12) Patent Application Publication
(10) Pub. No.: US 2021/0175737 A1
(43) Pub. Date: Jun. 10, 2021

(54) INDUSTRIAL WIRELESS CHARGING SYSTEM USING MAGNETIC RESONANCE MANNER

(71) Applicant: SUN HST Co., Ltd., Ulsan (KR)

(72) Inventors: Jin Yong LEE, Ulsan (KR); Jeong Hun LEE, Ulsan (KR); Su Jin LEE, Ulsan (KR); Myoung Hoon CHOI, Ulsan (KR); Jeong Hwan AHN, Ulsan (KR)

(21) Appl. No.: 17/105,698

(22) Filed: Nov. 27, 2020

(30) Foreign Application Priority Data
Dec. 4, 2019 (KR) 10-2019-0159766

(51) Int. Cl. H02J 7/04; H02J 50/80; H02J 50/12

(52) U.S. Cl. CPC H02J 7/04; H02J 50/12; H02J 50/80

(57) ABSTRACT

According to an embodiment, an industrial wireless charging system using a magnetic resonance manner comprises a pneumatic cylinder having a shaft and a body to reciprocate the shaft, a solenoid valve suppling and exhausting air to/from the body of the pneumatic cylinder, a position sensor installed in the body of the pneumatic cylinder, detecting a position of the shaft, and receiving power from a rechargeable battery, and a controller controlling an operation of the solenoid valve based on an input value to the position sensor. The controller includes a wireless charging transmitter to wirelessly supply charging energy in a magnetic resonance manner. The position sensor includes a wireless charging receiver to receive the charging energy and charge the battery with the charging energy in a magnetic resonance manner.

### CROSS-REFERENCE TO RELATED APPLICATION (S)

This application claims priority to Korean Patent Application No. 10-2019-0159766 filed in the Korean Intellectual Property Office on Dec. 4, 2019, the disclosure of which is incorporated by reference herein in its entirety.

### TECHNICAL FIELD

Embodiments of the disclosure relate to an industrial wireless charging system using a magnetic resonance scheme or manner.

### DISCUSSION OF RELATED ART

Numerous sensors are used in industrial sites. In the past, power for sensors mostly comes from a wired connection but it gradually tends to use wireless connections due to the burden of material costs and wiring work. Wireless devices include a battery and, when the battery is discharged, it needs to be replaced or recharged. Although recent products consume low power, the cycle of battery replacement is bound to be about 2-3 years.

Sensors used in industrial sites are changing from wired to wireless but are still not in wide use because of their short service life. Even if the lifespan is long, the data transmission period is too long, e.g., once every 30 minutes or once every hour, and the data transmission period is not continuous. In the case where real-time transmission of sensor data is needed, the battery, which has a short battery life, may be required to be replaced or recharged for reuse. While the battery is replaced or recharged, the industrial device using the battery is supposed to stop operate, thus causing loss.

The description disclosed in the Background section is only for a better understanding of the background of the invention and may also include information which does not constitute the prior art.

### SUMMARY

According to embodiments, there is provided an industrial wireless charging system using a magnetic resonance scheme or manner. According to an embodiment, there may be provided a wireless charging system capable of wirelessly supplying power to a sensor(s) within a predetermined distance (e.g., a few meters) thereof, using magnetic resonance-based wireless charging technology so as to minimize the work for replacing or charging the battery used in battery-powered wireless devices.

According to an embodiment, an industrial wireless charging system using a magnetic resonance manner comprises a pneumatic cylinder having a shaft and a body to reciprocate the shaft, a solenoid valve suppling and exhausting air to/from the body of the pneumatic cylinder, a position sensor installed in the body of the pneumatic cylinder, detecting a position of the shaft, and receiving power from a rechargeable battery, and a controller controlling an operation of the solenoid valve based on an input value to the position sensor. The controller includes a wireless charging transmitter to wirelessly supply charging energy in a magnetic resonance manner. The position sensor includes a wireless charging receiver to receive the charging energy and charge the battery with the charging energy in a magnetic resonance manner.

The position sensor includes a magnetic sensor to sense a magnetic field generated by the shaft.

The wireless charging transmitter includes a power transmitter receiving direct current (DC) power, converting the DC power into alternating current (AC) power, and transmitting the AC power, a power amplifier amplifying and outputting the AC power, and

a transmission antenna wirelessly transmitting the AC power output from the power amplifier. The wireless charging receiver includes a reception antenna receiving the AC power from the transmission antenna, a power receiver converting the AC power received from the reception antenna into DC power, a DC regulator regulating the DC power received from the power receiver, and a charger charging the battery with the DC power regulated by the DC regulator.

The transmission antenna and the reception antenna include a coil winding.

The wireless charging receiver further includes a receiver short-range wireless communication module receiving position information from the position sensor.

The receiver short-range wireless communication module allows power to be supplied from the charger directly to the position sensor while the position information is received from the position sensor and allows power to be supplied from the charger to the battery while the position information is not received from the position sensor.

The wireless charging transmitter further includes a transmitter short-range wireless communication module receiving battery charging information from the receiver short-range wireless communication module. The transmitter short-range wireless communication module stops the power transmitter from operating when the battery charging information received from the receiver short-range wireless communication module indicates that the battery is fully charged.

The transmitter short-range wireless communication module allows the power transmitter to operate when the battery charging information received from the receiver short-range wireless communication module indicates that the battery is not fully charged.

The transmitter short-range wireless communication module stops the power transmitter from operating while the controller outputs a control signal to the solenoid valve and allows the power transmitter to operate while no control signal is output to the solenoid valve.

According to an embodiment, there may be provided an industrial wireless charging system using a magnetic resonance scheme or manner. According to an embodiment, there may be provided a wireless charging system capable of wirelessly supplying power to a sensor(s) within a predetermined distance (e.g., a few meters) thereof, using magnetic resonance-based wireless charging technology so as to minimize the work for replacing or charging the battery used in battery-powered wireless devices.

### BRIEF DESCRIPTION OF THE DRAWINGS

A more complete appreciation of the disclosure and many of the attendant aspects thereof will be readily obtained as the same becomes better understood by reference to the following detailed description when considered in connection with the accompanying drawings, wherein:

FIGS. 1 and 2 are views illustrating an example cylinder equipped with an industrial wireless charging system using a magnetic resonance scheme or manner, according to an embodiment;

FIG. 3 is a view illustrating a cylinder equipped with an industrial wireless charging system using a magnetic resonance scheme or manner, according to an embodiment;

FIG. 4 is a block diagram illustrating a configuration of an industrial wireless charging system using a magnetic resonance scheme or manner, according to an embodiment; and

FIG. 5 is a block diagram illustrating a configuration of a wireless charging transmitter and a wireless charging receiver in an industrial wireless charging system using a magnetic resonance scheme or manner, according to an embodiment.

### DETAILED DESCRIPTION

Hereinafter, embodiments of the present invention are described in detail with reference to the accompanying drawings.

Embodiments of the disclosure are provided to thoroughly explain the disclosure to those skilled in the art, and various modifications may be made thereto, and the scope of the present invention is not limited thereto. Embodiments of the disclosure are provided to fully and thoroughly convey the spirit of the present invention to those skilled in the art.

As used herein, the thickness and size of each layer may be exaggerated for ease or clarity of description. The same reference denotations may be used to refer to the same or substantially the same elements throughout the specification and the drawings. As used herein, the term “A and/or B” encompasses any, or one or more combinations, of A and B. It will be understood that when an element or layer is referred to as being “on,” “connected to,” “coupled to,” or “adjacent to” another element or layer, it can be directly on, connected, coupled, or adjacent to the other element or layer, or intervening elements or layers may be present.

The terms as used herein are provided merely to describe some embodiments thereof, but not intended as limiting the present invention. As used herein, the singular forms “a,” “an,” and “the” are intended to include the plural forms as well, unless the context clearly indicates otherwise. As used herein, the term “comprise,” “include,” and/or “comprising” or “including” does not exclude the presence or addition of one or more other components, steps, operations, and/or elements than the component, step, operation, and/or element already mentioned.

As used herein, the terms “first” and “second” may be used to describe various members, parts, regions, areas, layers, and/or portions, but the members, parts, regions, areas, layers, and/or portions are not limited thereby. These terms are used merely to distinguish one member, part, region, area, layer, or portion from another. Accordingly, the term “first member,” “first part,” “first region,” “first area,” “first layer,” or “first portion” described herein may denote a “second member,” “second part,” “second region,” “second area,” “second layer,” or “second portion” without departing from the teachings disclosed herein.

The terms “beneath,” “below,” “lower,” “under,” “above,” “upper,” “on,” or other terms to indicate a position or location may be used for a better understanding of the relation between an element or feature and another as shown in the drawings. However, embodiments of the present invention are not limited thereby or thereto. For example, where a lower element or an element positioned under another element is overturned, then the element may be termed as an upper element or element positioned above the other element. Thus, the term “under” or “beneath” may encompass, in meaning, the term “above” or “over.”

As described herein, the controller (or control box or processor) and/or other related devices or parts may be implemented in hardware, firmware, application specific integrated circuits (ASICs), software, or a combination thereof. For example, the controller (or control box or processor), server, and/or other related devices or components or parts may be implemented in a single integrated circuit (IC) chip or individually in multiple IC chips. Further, various components of the controller (or control box or processor) may be implemented on a flexible printed circuit board, in a tape carrier package, on a printed circuit board, or on the same substrate as the controller. Further, various components of the controller (or control box) may be processes, threads, operations, instructions, or commands executed on one or more processors in one or more computing devices, which may execute computer programming instructions or commands to perform various functions described herein and interwork with other components.

The computer programming instructions or commands may be stored in a memory to be executable on a computing device using a standard memory device, e.g., a random access memory (RAM). The computer programming instructions or commands may be stored in, e.g., a compact-disc read only memory (CD-ROM), flash drive, or other non-transitory computer readable media. It will be appreciated by one of ordinary skill in the art that various functions of the computing device may be combined together or into a single computing device or particular functions of a computing device may be distributed to one or other computing devices without departing from the scope of the present invention.

As an example, the controller (or control box or processor) or server of the present invention may be operated on a typical commercial computer including a central processing unit, a hard disk drive (HDD) or solid state drive (SSD) or other high-volume storage, a volatile memory device, a keyboard, mouse, or other input devices, and a monitor, printer, or other output devices.

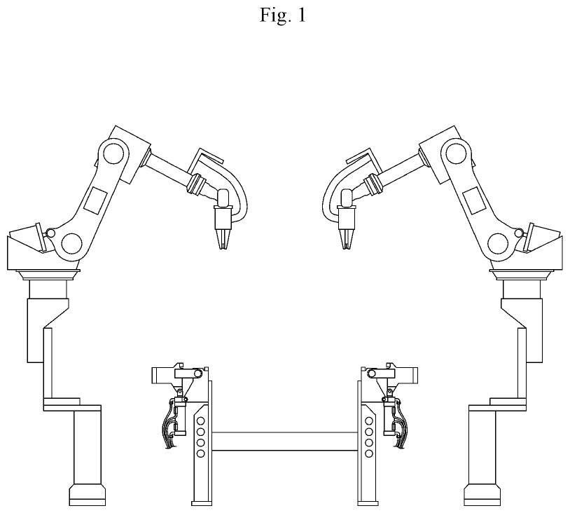

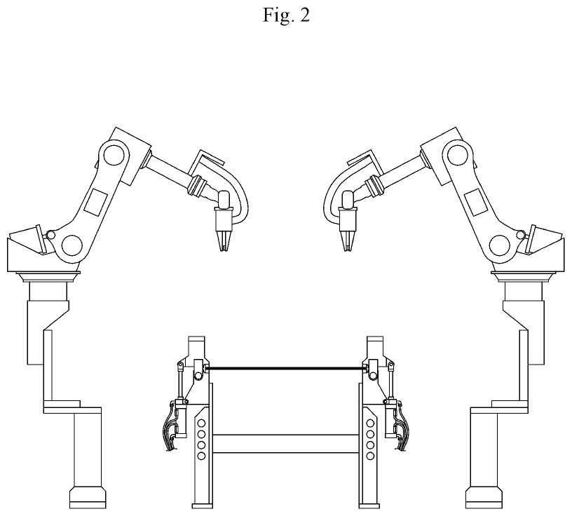

FIGS. 1 and 2 are views illustrating an example cylinder equipped with an industrial wireless charging system using a magnetic resonance scheme or manner, according to an embodiment.

As shown in FIGS. 1 and 2, the industrial wireless charging system using a magnetic resonance scheme or manner, according to an embodiment, may wirelessly supply power to magnetic sensors (or location or position sensors) that check the operation state of the pneumatic or hydraulic cylinders used in the clamp jigs in an automobile production plant. The clamp jig is a device to hold the panel to perform work, such as welding or applying silicon.

FIG. 1 illustrates an example in which a car side panel is placed on the jig to weld the side panel in which case the cylinder is in an open state (backed-off state). FIG. 2 illustrates an example in which a panel fixed to the jig is welded in which case the cylinder is in a closed state (advanced state).

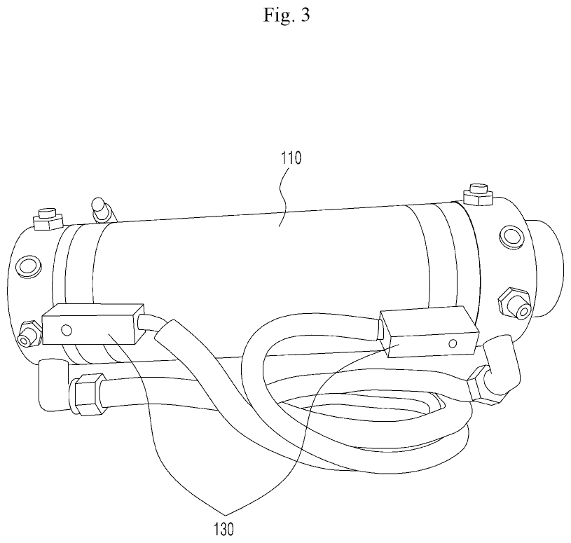

FIG. 3 is a view illustrating a cylinder equipped with an industrial wireless charging system using a magnetic resonance scheme or manner, according to an embodiment.

Referring to FIG. 3, two magnetic sensors 130 may be positioned on both sides of the body of the cylinder 110 and, by the magnetic field values sensed by the magnetic sensors 130, it may be known or determined whether the shaft of the cylinder 110 is in the advanced or backed-off state. When one or two cylinders are used, there may be no need for recharging the battery in a wireless manner.

However, when more cylinders are used, two magnetic sensors are attached onto each cylinder and may consume more power and may thus be required to be connected to a separate power source in which case more costs and time may be consumed. Thus, it may be required to reduce material costs and work time for connecting to a power source.

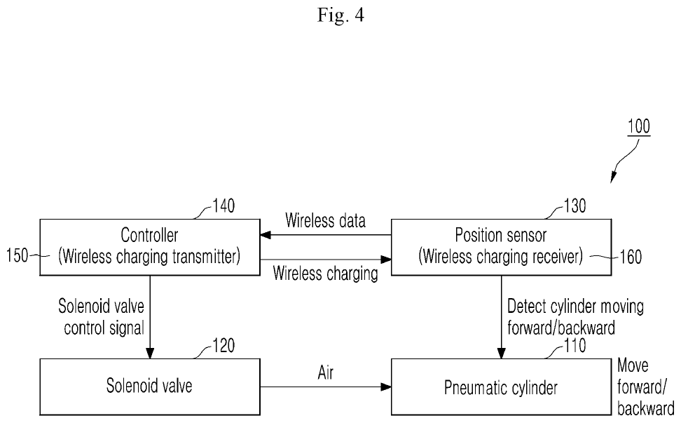

FIG. 4 is a block diagram illustrating a configuration of an industrial wireless charging system 100 using a magnetic resonance scheme or manner, according to an embodiment.

Referring to FIG. 4, an industrial wireless charging system 100 using a magnetic resonance scheme or manner, according to an embodiment, may include a pneumatic cylinder 110, a solenoid valve 120, a position sensor 130 (e.g., a magnetic sensor), a controller 140, a wireless charging transmitter 150, and a wireless charging receiver 160.

The pneumatic cylinder 110 (or a hydraulic cylinder) may include a shaft and a body to reciprocate the shaft. When air is supplied through a first side of the shaft-coupled body and exhausted through a second side (e.g., the side opposite the first side) of the shaft-coupled body, the shaft may be moved in a first direction and, when air is exhausted through the first side of the shaft-coupled body and is supplied through the second side of the shaft-coupled body, the shaft linearly moves in a second direction opposite to the first direction.

The solenoid valve 120 allows air to be supplied and exhausted to/from the body of the pneumatic cylinder 110. As an example, the solenoid valve 120 opens, closes, or switches the air path so that the air is supplied through the first side of the body of the pneumatic cylinder 110 and exhausted through the second side of the body of the pneumatic cylinder 110 or so that the air is exhausted through the first side of the body of the pneumatic cylinder 110 and supplied through the second side of the body of the pneumatic cylinder 110.

The position sensor 130 may be installed on the body of the cylinder and may sense the position of the shaft and transmit the sensed position to the controller 140. As an example, the position sensor 130 may be installed on each of both sides of the body of the cylinder, sensing the current position of the shaft and transmitting the sensed value to the controller 140. According to an embodiment, the position sensor 130 may be a magnetic sensor (e.g., a magnetic field sensor) or may be a proximity sensor or limit sensor. The position sensor 130 may receive power from a rechargeable battery 170. According to an embodiment, the position sensor 130 may receive power from the battery 170 and/or a charger 164.

The controller 140 may control the operation of the solenoid valve 120 based on the input value from the position sensor 130. For example, when the input value from the position sensor 130 is value A of predetermined values A and B, the controller 140 may control the solenoid valve 120 to perform operation C (e.g., supplying air through the first side of the body and exhausting air through the second side of the body) of predetermined operations C and D and, when the input value from the position sensor 130 is value B, the controller 140 may control the solenoid valve 120 to perform operation D (e.g., exhausting air through the first side of the body and supplying air through the second side of the body) of predetermined operations C and D.

The wireless charging transmitter 150 may be installed in the controller 140 and wirelessly transmit charging energy in a magnetic resonance manner. The wireless charging receiver 160 may be installed in the position sensor 130 and wirelessly receive the charging energy and charge the battery 170 in a magnetic resonance manner.

The operation of the wireless charging transmitter 150 and the wireless charging receiver 160 may be precisely, accurately, or finely controlled based on the operation state of the position sensor 130 and/or the operation state of the controller 140, so that the overall operation efficiency of the system 100 may be enhanced.

As such, according to an embodiment, there may be provided a wireless charging system 100 capable of wirelessly supplying power to the position sensor 130 within a predetermined distance (e.g., a few meters) using magnetic resonance-based wireless charging technology so as to minimize the work of replacing or charging the battery in the position sensor 130 using the battery 170.

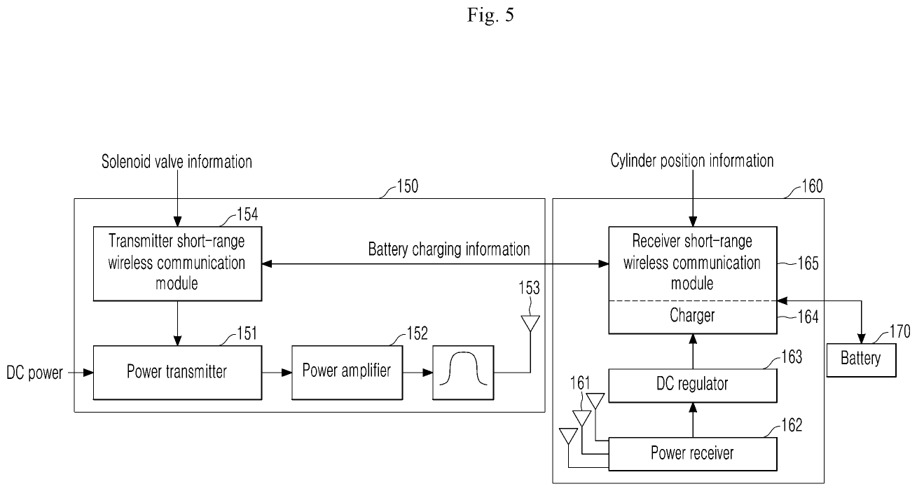

FIG. 5 is a block diagram illustrating a configuration of a wireless charging transmitter 150 and a wireless charging receiver 160 in an industrial wireless charging system 100 using a magnetic resonance scheme or manner, according to an embodiment. The configuration and operation of the wireless charging system 100 are described below with reference to FIG. 4.

Referring to FIG. 5, the wireless charging transmitter 150 may include a power transmitter 151, a power amplifier 152, and a transmission antenna 153. The wireless charging transmitter 150 may further include a transmitter short-range wireless communication module 154.

The power transmitter 151 may receive DC power which is used as power for the controller 140 and convert the DC power into AC power (e.g., radio frequency (RF) energy or power) and output the AC power. According to an embodiment, an oscillator may be connected to the power transmitter 151 to obtain a predetermined frequency. The power amplifier 152 may amplify the AC power received from the power transmitter 151 to a predetermined level and output the amplified AC power. The transmission antenna 153 may convert the AC power output from the power amplifier 152 and transmit the converted AC power. For example, the transmission antenna 153 may convert the AC power output from the power amplifier 152 into a radio wave (or radio waveform) and transmit the radio wave. The transmission antenna 153 may include a coil winding for performing magnetic resonance. The coil winding may be a coil wound several times. By the configuration, the power transmitter 151 may supply power to the power receiver 162 in a magnetic resonance manner or scheme.

The transmitter short-range wireless communication module 154 may receive charging information of the battery 170 from the receiver short-range wireless communication module 165, and the transmitter short-range wireless communication module 154 may receive state information of the solenoid valve 120 from the controller 140. According to an embodiment, an oscillator may be connected to the transmitter short-range wireless communication module 154 to obtain a predetermined frequency.

Thus, according to an embodiment, the transmitter short-range wireless communication module 154 may transmit a stop signal, which stops the power transmitter 151 from operating, to the power transmitter 151 when the charging information of the battery 170 received from the receiver short-range wireless communication module 165 indicates that the battery 170 is fully charged. According to an embodiment, the transmitter short-range wireless communication module 154 may transmit an operation signal, which enables the power transmitter 151 to operate, to the power transmitter 151 when the charging information of the battery 170 received from the receiver short-range wireless communication module 165 indicates that the battery 170 is not fully charged, e.g., the power level of the battery 170 is lower than the power level of the battery 170 when fully charged. Thus, whether to operate the wireless charging transmitter 150 may be determined depending on the charging state of the battery 170, thus preventing energy waste in the wireless charging transmitter 150.

The transmitter short-range wireless communication module 154 and the receiver short-range wireless communication module 165 may include at least one of predetermined short-range communication means, e.g., infrared (IR) communication devices or circuits, radio frequency (RF) communication devices or circuits, Bluetooth devices or circuits, Wireless LAN devices or circuits, wireless-fidelity (Wi-Fi) devices or circuits, and Zigbee devices or circuits, and/or all types of short-range wireless communication means to be equipped therein in the future.

According to an embodiment, the transmitter short-range wireless communication module 154 may receive the information of the solenoid valve 120 from the controller 140 and may stop the power transmitter 151 from operating while the controller 140 outputs the control signal to the solenoid valve 120 and allow the power transmitter 151 to operate while the controller 140 outputs no control signal to the solenoid valve 120. Thus, whether to operate the wireless charging transmitter 150 may be determined depending on the controlling state of the controller 140 and/or solenoid valve 120, thus preventing energy waste in the wireless charging transmitter 150. According to an embodiment, the wireless charging transmitter 150 may be controlled to operate regardless of the controlling state of the controller 140 and/or the solenoid valve 120.

Referring to FIG. 5, the wireless charging receiver 160 may include a reception antenna 161, a power receiver 162, a DC regulator 163, and a charger 164. The wireless charging receiver 160 may further include a receiver short-range wireless communication module 165.

The reception antenna 161 may wirelessly receive AC power from the transmission antenna 153. There may be provided multiple reception antennas 161 to enhance the reception efficiency. The reception antenna 161 may include a coil winding to be operated in a magnetic resonance manner. The coil winding may be a coil wound several times. The power receiver 162 may convert the AC power received from multiple reception antennas 161 into DC power, rectify the DC power, and output the rectified DC power. The DC regulator 163 may regulate and thus stabilize the DC power received from the power receiver 162 and then output the regulated DC power. The charger 164 may charge the battery 170 with the DC power from the DC regulator 163. The charger 164 may charge the battery 170 or supply power to the position sensor 130 while charging the battery 170, or the charger 164 may stop charging the battery 170 while directly supplying power to the position sensor 130.

The receiver short-range wireless communication module 165 may receive position information from the position sensor 130 and charging information from the charger 164 and/or battery 170. According to an embodiment, an oscillator may be connected to the receiver short-range wireless communication module 165 to obtain a predetermined frequency.

Thus, according to an embodiment, the receiver short-range wireless communication module 165 may output a control signal to the charger 164 to allow the power to be supplied from the charger 164 directly to the position sensor 130 while receiving the position information from the position sensor 130 (at this time, the battery 170 may, or may not be, supplied power), and the receiver short-range wireless communication module 165 may output a control signal to the charger 164 to allow the power to be supplied from the charger 164 to the battery 170 while the position information is not received from the position sensor 130.

Thus, the wireless charging receiver 160 allows the ratio of power supply to the position sensor 130 and the battery 170 to be determined depending on the controlling state of the position sensor 130, thus stably operating the position sensor 130 and efficiently charging the battery 170. Further, the wireless charging receiver 160, e.g., the receiver short-range wireless communication module 165, transmits the charging information (e.g., information indicating that the battery 170 is fully charged, over-charged, or over-discharged) of the battery 170 to the wireless charging transmitter 150, e.g., the transmitter short-range wireless communication module 154, thereby allowing the wireless charging transmitter 150 to be operated more efficiently. As an example, when the battery 170 is fully charged, the wireless charging transmitter 150 may be stopped from operating, thus preventing unnecessary energy consumption or waste.

As such, according to an embodiment, the industrial wireless charging system 100 using a magnetic resonance scheme or manner may wirelessly supply power to the position sensor 130 within a predetermined distance (e.g., a few meters) using magnetic resonance-based wireless charging technology so as to minimize the work of replacing or charging the battery in the position sensor 130 using the battery 170. Further, according to an embodiment, in the wireless charging system 100, the operation of the wireless charging transmitter 150 and/or the wireless charging receiver 160 may be accurately controlled based on the charging information (e.g., information indicating the battery 170 is fully charged) of the battery 170, position information of the pneumatic cylinder 110 (or the operation information of the position sensor 130), and/or control information of the controller 140 (or the operation information of the solenoid valve 120), thereby allowing the operation of each device to be performed smoothly while preventing energy waste.

While the disclosure has been shown and described with reference to exemplary embodiments thereof, it will be apparent to those of ordinary skill in the art that various changes in form and detail may be made thereto without departing from the spirit and scope of the disclosure as defined by the following claims.

What is claimed is:

1. An industrial wireless charging system using a magnetic resonance manner, the industrial wireless charging system comprising:
a pneumatic cylinder having a shaft and a body to reciprocate the shaft;
a solenoid valve suppling and exhausting air to/from the body of the pneumatic cylinder;
a position sensor installed in the body of the pneumatic cylinder, detecting a position of the shaft, and receiving power from a rechargeable battery; and
a controller controlling an operation of the solenoid valve based on an input value to the position sensor, wherein
the controller includes a wireless charging transmitter to wirelessly supply charging energy in a magnetic resonance manner, and wherein the position sensor includes a wireless charging receiver to receive the charging energy and charge the battery with the charging energy in a magnetic resonance manner.

2. The industrial wireless charging system of claim 1, wherein
the position sensor includes a magnetic sensor to sense a magnetic field generated by the shaft.

3. The industrial wireless charging system of claim 1, wherein
the wireless charging transmitter includes:
a power transmitter receiving direct current (DC) power, converting the DC power into alternating current (AC) power, and transmitting the AC power;
a power amplifier amplifying and outputting the AC power; and
a transmission antenna wirelessly transmitting the AC power output from the power amplifier, and wherein the wireless charging receiver includes:
a reception antenna receiving the AC power from the transmission antenna;
a power receiver converting the AC power received from the reception antenna into DC power;
a DC regulator regulating the DC power received from the power receiver; and
a charger charging the battery with the DC power regulated by the DC regulator.

4. The industrial wireless charging system of claim 3, wherein
the transmission antenna and the reception antenna include a coil winding.

5. The industrial wireless charging system of claim 3, wherein
the wireless charging receiver further includes a receiver short-range wireless communication module receiving position information from the position sensor, and wherein
the receiver short-range wireless communication module allows power to be supplied from the charger directly to the position sensor while the position information is received from the position sensor and allows power to be supplied from the charger to the battery while the position information is not received from the position sensor.

6. The industrial wireless charging system of claim 5, wherein
the wireless charging transmitter further includes a transmitter short-range wireless communication module receiving battery charging information from the receiver short-range wireless communication module, and wherein
the transmitter short-range wireless communication module stops the power transmitter from operating when the battery charging information received from the receiver short-range wireless communication module indicates that the battery is fully charged.

7. The industrial wireless charging system of claim 6, wherein
the transmitter short-range wireless communication module allows the power transmitter to operate when the battery charging information received from the receiver short-range wireless communication module indicates that the battery is not fully charged.

8. The industrial wireless charging system of claim 6, wherein
the transmitter short-range wireless communication module stops the power transmitter from operating while the controller outputs a control signal to the solenoid valve and allows the power transmitter to operate while no control signal is output to the solenoid valve.
